(19) United States
(12) Patent Application Publication
(10) Pub. No.: US 2008/0024922 A1
(43) Pub. Date: Jan. 31, 2008

(54) Auxiliary slider-debonding device and slider debonding method

(75) Inventors: Tatsuya Satoyoshi, Hong Kong (CN); YatWing Chiu, Hong Kong (CN); Peng Liu, Dongguan (CN); ShiXing Zhao, Dongguan (CN); KeQuan Liu, Dongguan (CN); ShingCheong Lau, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd.,, Hong Kong (CN)

(21) Appl. No.: 11/878,458

(22) Filed: Jul. 24, 2007

(30) Foreign Application Priority Data
Jul. 28, 2006 (CN) 200610109054.7

(51) Int. Cl. G11B 5/60

(52) U.S. Cl. 360/234.3

(57) ABSTRACT

An auxiliary slider-debonding device for debonding a plurality of sliders from a transfer tool and receiving them therein includes: a locating device to locate the transfer tool and a debonding tray to receive the sliders. The debonding tray includes at least an array of first pockets arranged in a direction consistent with an arranging direction of the sliders, and an array of second pockets arranged in a direction parallel to the array of first pockets. A stage is defined between any two adjacent first pockets, and length of the stage along the arranging direction of the first pockets is larger than the length of a slider along the same direction. Each second pocket has a same position as that of a closest stage along the arranging direction of the first pockets. The invention also discloses a method for debonding and receiving the sliders used therein.

### FIELD OF THE INVENTION

The invention relates to a device and method for manufacturing information recording disk drive units, particularly to a device and method for manufacturing sliders used in the disk drive units, and more particularly, the invention relates to an auxiliary slider-debonding device for debonding a plurality of sliders from a transfer tool and a slider debonding method used therein.

### BACKGROUND OF THE INVENTION

One known type of information storage device is a disk drive device that uses magnetic media to store data and a slider having a read/write head movably positioned over the magnetic media to selectively read data from or write data to the magnetic media.

The above sliders are formed by processing a wafer which is generally used to manufacture sliders through a series of procedures. At first, the wafer is subjected to a lapping process, a cleaning process, a deposition process and an etching process. Then, the processed wafer is sliced into a plurality of row bars by a suitable tool such as a diamond cutting wheel, each row bar comprising a plurality of slider arrays. Next, each row bar is subjected to a series of subsequent procedures (including slider array electrical characteristics test). Then, each row bar is cut into individual sliders by a cutter e.g., the aforementioned diamond-cutting wheel. After that, non-defective sliders are singled out from all the sliders obtained according to the above method by a sorting procedure. Then, the non-defective sliders are cleaned and finally, these cleaned and non-defective sliders are assembled to respective disk drive units.

During the above row bar cutting process, the row bars are usually bonded on a transfer tool temporarily by adhesive glue or wax for facilitating operation, and then, the row bars are sliced into individual sliders. Because the separated sliders are still bonded on the transfer tool by the adhesive glue or wax, the bonding glue or wax have to be removed so that the sliders can be debonded from the transfer tool. The separate sliders are generally placed into a debonding tray in sequence in order to facilitate selection operation of non-defective sliders in a subsequent process. In the industry, there are various methods for debonding sliders from a transfer tool and placing them into a debonding tray. Now these methods are introduced respectively.

FIGS. 1a-1e illustrate a conventional hot plate debonding method. As shown in FIGS. 1a-1b, a plurality of sliders 101 is fixed on a surface of a transfer tool 102 by adhesive. Then, as shown in FIG. 1c, the transfer tool 102 is mounted on a hot plate 103. Next, the hot plate 103 is heated to a certain temperature so that the transfer tool 102 is baked by a high temperature. When the temperature reaches the melting point of the adhesive, the adhesive is melted such that the sliders 101 are free from restraint of the adhesive. Finally, the sliders 101 are transferred one by one to respective pockets 106 of a debonding tray 105 (see FIG. 1e) via a tweezers 104 (see FIG. 1d).

Though the above method can effectively separate the sliders from the transfer tool and place them into the debonding tray; however, since each slider is small in volume and weight, and the distance between two adjacent sliders is very narrow, slight jolting or air-flowing (such as breeze) can both cause movement of the sliders. Accordingly, during the process of transferring a great number of sliders from the transfer tool to the debonding tray one by one via the tweezers, the sliders are easily disordered due to jolting or collision (for example body tremor of an operator or collision between the tweezers and the sliders) such that the sliders are mixed with each other, thus making the sliders unable to be stored into suitable pockets of the debonding tray according to their original order on the transfer tool. The disorder of the sliders in the debonding tray makes it impossible for an operator to directly implement slider selection work according to both electric performances of the sliders tested before the sliders are formed by cutting process and the original relative locations of the sliders. On the contrary, if such disorder of the sliders happens, it is inevitable to read one by one an identifying number formed on a deposition surface of each slider. The identifying number is marked on the deposition surface of each slider in size of about 5×10 μm per word. However, as the deposition surface of each slider in the pockets is placed to be parallel to sidewalls of the pocket, the operator can't catch sight of the identifying numbers directly via a microscope; and resultantly, the sliders have to be taken out from the slider pockets one by one via tools such as a tweezers to ascertain the identifying number of each slider via the microscope, thus resulting in confusion of the sliders in the pockets of the debonding tray, and making it difficult to select sliders. In addition, the method uses high temperature which may easily hurt the operator during operation. For example, the operator may be hurt by the hot plate, and moreover, the manual operation suffers from low work efficiency as well.

FIGS. 2a-2d show a process of debonding plural sliders from a transfer tool and placing them into a debonding tray using a solvent debonding method. As shown in FIG. 2a, a transfer tool 202 with a number of sliders 201 attached thereon by adhesive is placed in a tank 203 containing solution 205. The solution 205, such as solution containing NMP (N-methylpyrrolidone) or IPA (isopropanol) solvent dissolves the adhesive such that connection between the sliders 201 and the transfer tool 202 is eliminated. After that, as shown in FIG. 2b, the solution 205 is expelled from the tank 203 through a discharging valve 206. During the process of dissolving the adhesive by the solution 205, an ultrasonic device 204 may also be used to accelerate dissolving speed. After that, a tweezers 207 (as that shown in FIG. 2c) is used to transfer the sliders 201 from the transfer tool 202 to pockets 209 of a debonding tray 208 (as that shown in FIG. 2d). Though the solvent debonding method is relatively safe (without danger of high temperature burning) compared with the hot plate debonding method, the method still uses tweezers to transfer sliders by manual; accordingly, problem of slider confusion exists, thus making it difficult to select the sliders in a subsequent process. In addition, manual operation causes low work efficiency.

There is also an improved solvent debonding method used in this field. As shown in FIGS. 3a-3e, a transfer tool 302 with a plurality of sliders 301 attached on one surface thereof by adhesive is fixed on a load plate 303. The load plate 303 is further mounted on a debonding tray 304 for receiving sliders, thus forming an assembly 300. The load plate 303 has a plurality of guide posts 305 formed thereon and the debonding tray 304 has a plurality of guide bushings 306 corresponding to the guide posts 305. The guide posts 305 are inserted in the guide bushings 306 respectively, thus achieving alignment of the load plate 303 with the debonding tray 304, and ensuring that the sliders 301 are aligned with the pockets 309 of the debonding tray 304. As shown in FIG. 3c, the assembly 300 is dipped in a solution 307. The solution 307 dissolves the adhesive such that connection between the sliders 301 and the transfer tool 302 is eliminated. Each slider 301 directly drops into respective pocket 309 located therebelow due to gravity. In comparison with the aforementioned slider debonding method, as the improved slider debonding method can quickly transfer all the sliders to the pockets of the debonding tray once the sliders are separated from the transfer tool, it has higher work efficiency. However, as the cutting pitch along which the row bar is cut into sliders is very narrow, and accordingly, for ensuring that the separate sliders can accurately fall into respective pockets, the pitch (denoted with numeral 311 in FIG. 3e) between the pockets of the debonding tray must conform to the above cutting pitch. That is, the pitch must also be very narrow. However, as the slider is small in size and weight, it is susceptible to external jolting or air-flowing such that the slider is displaced easily, and therefore, the slider may easily fall into another pocket by mistake, thus causing slider confusion and complicating later slider-selecting process. Moreover, the very narrow pitch between the pockets increases manufacture cost, as narrower pitch will cause the manufacture process to become more difficult.

Hence, it is desired to provide an improved slider debonding method and device to solve the above-mentioned problem.

### SUMMARY OF THE INVENTION

A main purpose of the present invention is to provide an auxiliary slider-debonding device and a method used therein, which can effectively avoid or reduce confusion of sliders during a process of transferring them from a transfer tool to a debonding tray.

Another purpose of the present invention is to provide an auxiliary slider-debonding device and a method used therein, which can simplify structure of the debonding tray and reduce manufacture cost thereof.

To attain the above purposes, the present invention provides an auxiliary slider-debonding device for debonding a plurality of sliders from a transfer tool, which comprises: a locating device to locate the transfer tool and a debonding tray to receive the sliders. The debonding tray comprises at least an array of first pockets arranged in a direction consistent with an arranging direction of the sliders carried on the transfer tool, and an array of second pockets arranged in a direction parallel to the array of first pockets. A stage is defined between any two adjacent first pockets, and the length of the stage along the arranging direction of the first pockets is larger than the length of a slider along the same direction. Along the arranging direction of the first pockets, each second pocket and a stage closest thereto has a same position.

In an embodiment of the invention, the slider-debonding device further comprises a guardrail plate disposed between and parallel to the locating device and the debonding tray. The distance between the guardrail plate and the debonding tray is smaller than the thickness of a slider. At least a receiving-slot parallel to the array of first pockets or second pockets is formed on the guardrail plate, and the receiving-slot comprises a gap corresponding to the array of first pockets, and a plurality of notches formed at one side of the gap and corresponding to the array of second pockets. A stopper is defined between any two adjacent notches for restraining position of the sliders. The guardrail plate further has a locating slot defined therein, which communicates the receiving-slot and which is used to locate the transfer tool. Guiding wires are provided in the gap and extend along two lateral sides of each notch to guide movement of each slider. The guardrail plate has two side portions parallel to the receiving-slot; a plurality of securing posts is formed on one of the side portions, one end of each guiding wire is tied on respective securing post and the other end thereof is adjustably tied on the other side portion of the guardrail plate. A wire-adjusting shaft is mounted on one side portion opposite to another side portion where the securing posts are formed of the guardrail plate; a plurality of tension-adjusting posts corresponding to the securing posts is formed on the wire-adjusting shaft; the other end of each guiding wire is tied on respective tension-adjusting post, and tension of the guiding wire is adjusted by rotating the wire-adjusting shaft. The guardrail plate has a plurality of register posts formed thereon, the debonding tray has a plurality of register holes formed thereon corresponding to the register posts, and the register posts are inserted into the register holes respectively.

The locating device comprises a locating plate positioned over and parallel to the debonding tray, and the locating plate has a mounting-slot for mounting the transfer tool therein. The locating device further comprises a spring constructed by a horizontal portion and a resilient contact portion connected to the horizontal portion; and the resilient contact portion passes through the mounting-slot and resiliently touches an inner sidewall of the mounting-slot. The locating device further comprises a spring-mounting plate which is assembled on the locating plate and which has a hole defined therein. The hole is aligned with the mounting-slot, and the horizontal portion of the spring is secured on a top position of the hole.

The device further comprises a support plate for supporting the locating device and the debonding tray. The support plate is constructed by a bottom plate and an assembling plate assembled on the bottom plate.

A method for debonding sliders from a transfer tool and receiving them together, comprises the steps of: (1) providing an auxiliary slider-debonding device as recited in claim 1; (2) mounting the transfer tool, which has a plurality of sliders attached on one surface thereof by adhesive, to the locating device of the auxiliary slider-debonding device such that the sliders locate over the first pockets and the stages of the debonding tray of the auxiliary slider-debonding device; (3) obliquely immersing the auxiliary slider-debonding device in a tank containing a solution such that the first pockets are higher than the second pockets of the debonding tray; (4) dissolving the adhesive by the solution so that the sliders are debonded from the transfer tool; (5) causing the sliders to drop into the front pockets or drop on the stages and then slip into the second pockets.

The invention has several advantages: firstly, by changing a single array of pockets, which are formed on a conventional debonding tray and which have a same pitch as the sliders mounted on a transfer tool, to double arrays of pockets in parallel and interlaced fashion, and by defining a stage between any two adjacent pockets of one array for temporarily carrying the sliders, the pitch between any two pockets of each array is lengthened greatly. When the debonding tray is obliquely placed such that the array of pockets having the stages is higher than another array of pockets, the sliders debonded from the transfer tool will fall into one array of pockets or fall on the stages and then slip into the other array of pockets, thus reducing or even avoiding confusion of the sliders. In addition, increased pitch between any two adjacent pockets makes structure of the debonding tray more simplified, thus reducing manufacture cost.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate understanding of the various embodiments of this invention. In such drawings:

FIG. 1a shows a plan view of a transfer tool and a plurality of sliders mounted on the transfer tool;

FIG. 1b shows an enlarged, partial view of part A of the structure shown in FIG. 1a;

FIG. 1c shows a plan view of a transfer tool and a plurality of sliders fixed on a hot plate used in a conventional hot plate debonding method;

FIG. 1d shows a front view of a tweezers used in a conventional hot plate debonding method for transferring separated sliders from a transfer tool to a debonding tray;

FIG. 1e shows a plan view of a debonding tray used in a conventional hot plate debonding method;

FIG. 2a shows a status after a transfer tool with a number of sliders mounted thereon is placed into a tank containing solvent according to a conventional solvent debonding method;

FIG. 2b shows a status of the tank shown in FIG. 2a after the solvent contained therein is expelled out of the tank;

FIG. 2c shows a front view of a tweezers used in the method shown in FIG. 2a to transfer separated sliders from a transfer tool to a debonding tray;

FIG. 2d shows a plan view of the debonding tray used in the conventional solvent debonding method to receive sliders;

FIG. 3a shows an exploded view of a device used in an improved solvent debonding method;

FIG. 3b shows a view of the structure of FIG. 3a in an assembled state;

FIG. 3c shows a status after the device shown in FIG. 3b is immersed in the solvent;

FIG. 3d shows a plan view of a debonding tray used in the improved solvent debonding method for receiving separated sliders;

FIG. 3e shows an enlarged, partial view of part B of the debonding tray of FIG. 3d;

FIG. 4a is an exploded view of an auxiliary slider-debonding device according to an embodiment of the invention;

FIG. 4b is a plan view of the structure shown in FIG. 4a in an assembled state;

FIG. 4c is a front view of a transfer tool of FIG. 4a;

FIG. 4d is a side view of the transfer tool of FIG. 4a;

FIG. 4e is an enlarged, partial view of part F of the transfer tool of FIG. 4a;

FIG. 5a is a top plan view of a debonding tray of FIG. 4a;

FIG. 5b is an enlarged, partial view of part C of the debonding tray of FIG. 5a;

FIG. 6a is an exploded view of a guardrail plate of FIG. 4a;

FIG. 6b is a view of the guardrail plate of FIG. 6a in an assembled state;

FIG. 6c is a cross-sectional view of the guardrail plate of FIG. 6b along line E-E;

FIG. 6d is an enlarged, partial view of part D of the guardrail plate of FIG. 6a;

FIG. 7a is an exploded view of a locating device and the transfer tool shown in FIG. 4a;

FIG. 7b shows a status after the locating device and the transfer tool shown in FIG. 7a are assembled together;

FIG. 8a shows a view of a support component of FIG. 4a in an assembling state;

FIG. 8b is a top plan view of the assembled support component of FIG. 8a;

FIG. 9 shows a flowchart illustrating a slider-debonding method according to an embodiment of the invention;

FIG. 10 shows a status after an auxiliary slider-debonding device is obliquely put in a tank containing solution according to an embodiment of the invention;

FIG. 11a shows a status after the sliders held by the device shown in FIG. 10 left the transfer tool and droped onto the debonding tray;

FIG. 11b is a cross-sectional view of structure of FIG. 11a along line H-H showing a first array of sliders locating over a first array of slider-receiving pockets of the debonding tray;

FIG. 11c is a cross-sectional view of structure of FIG. 11a along line K-K showing a second array of sliders locating over stages which are formed between the first array of slider-receiving pockets of the debonding tray;

FIG. 12a shows a status after the sliders left the transfer tool of the device shown in FIG. 10a and are completely received in the slider-receiving pockets of the debonding tray;

FIG. 12b is a cross-sectional view of structure of FIG. 12a along line H-H showing the first array of sliders completely received in the first array of slider-receiving pockets of the debonding tray;

FIG. 12c is a cross-sectional view of structure of FIG. 12a along line K-K showing the second array of sliders completely received in the second array of slider-receiving pockets of the debonding tray.

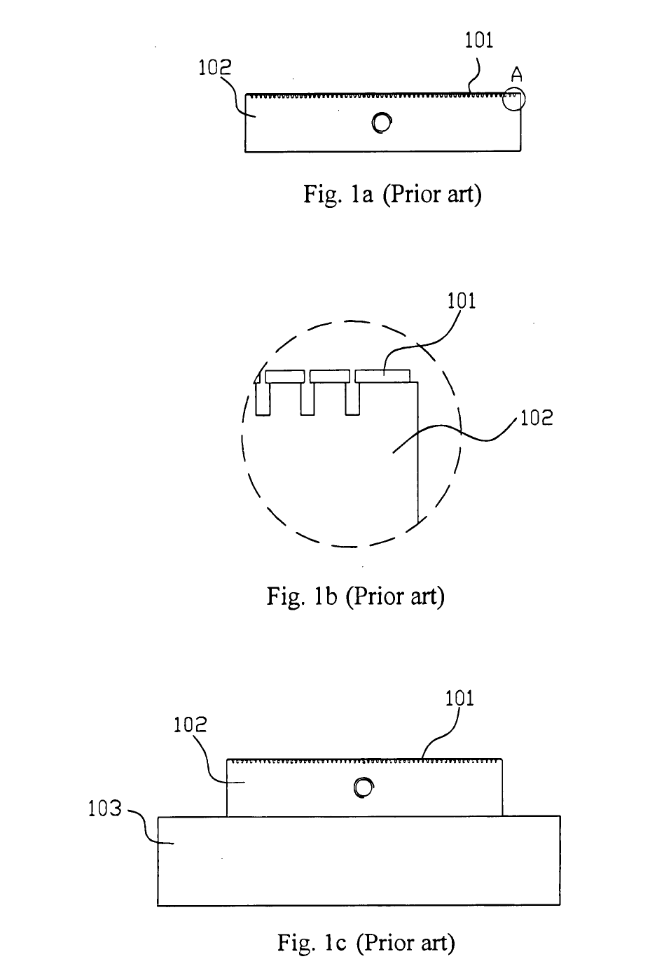

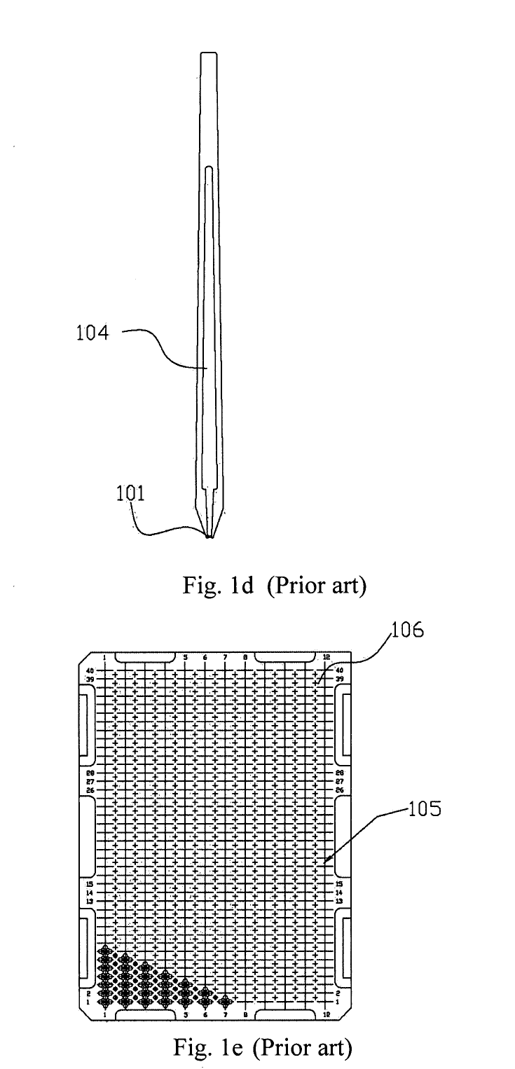

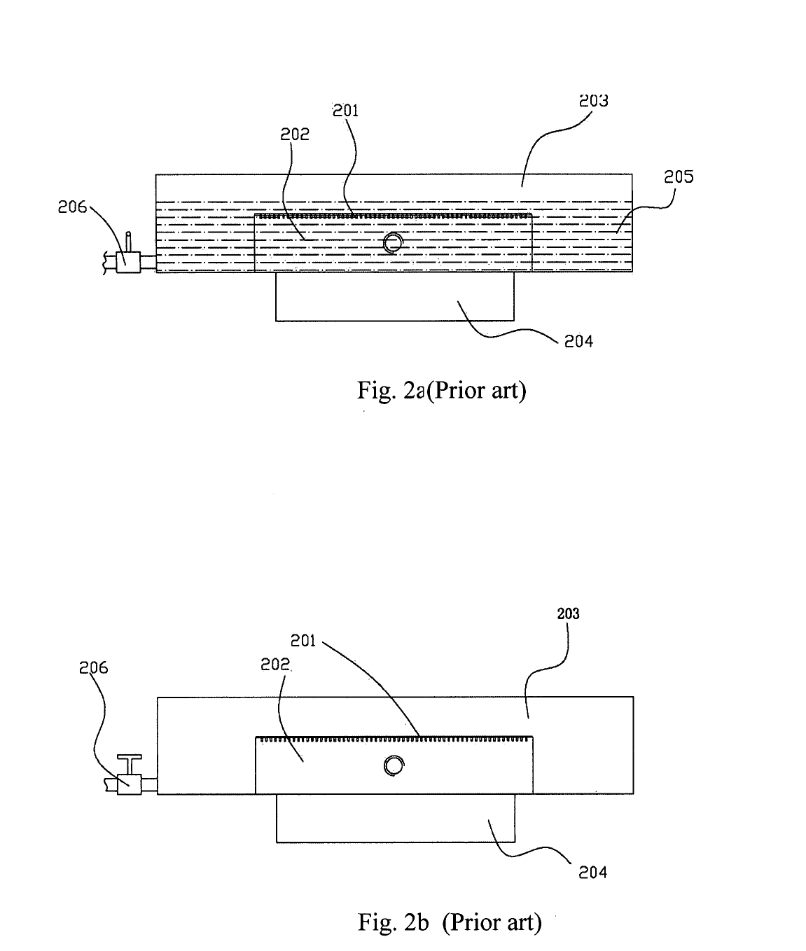

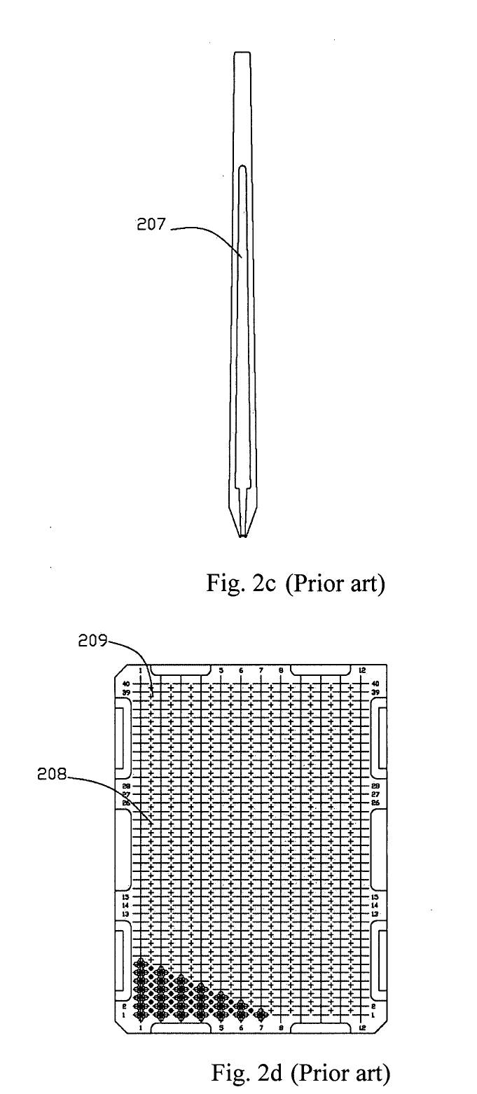

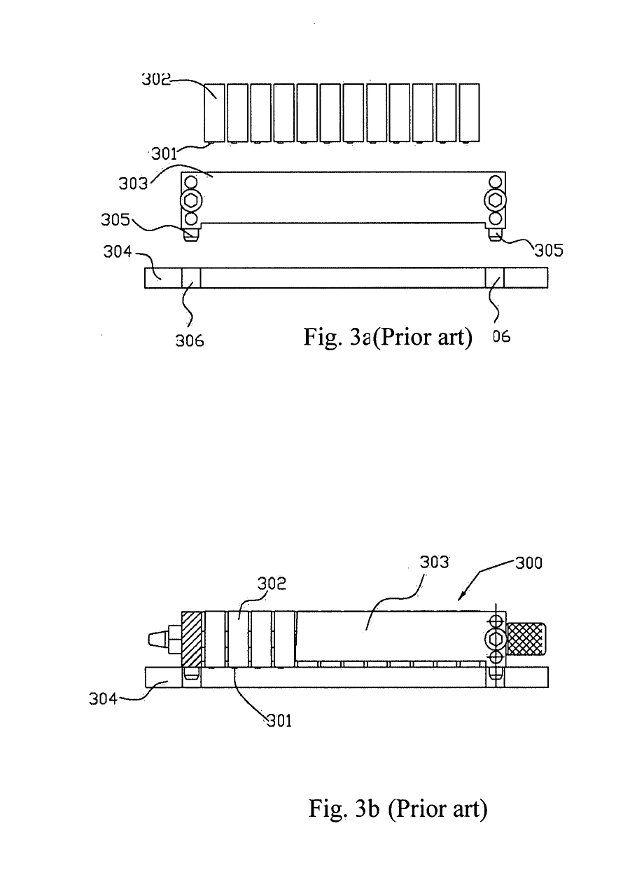

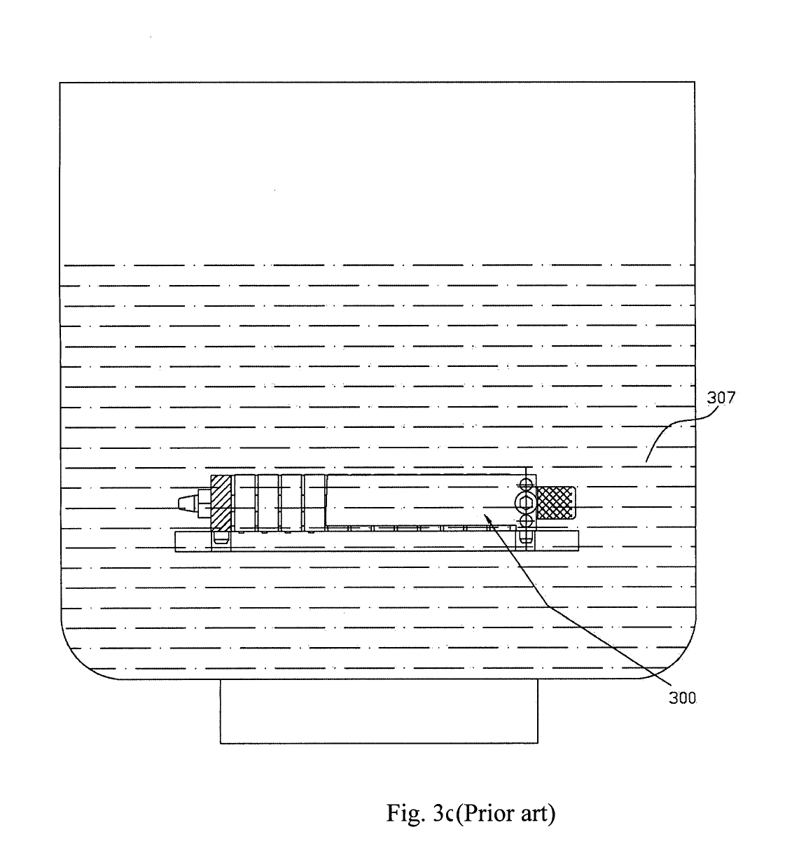

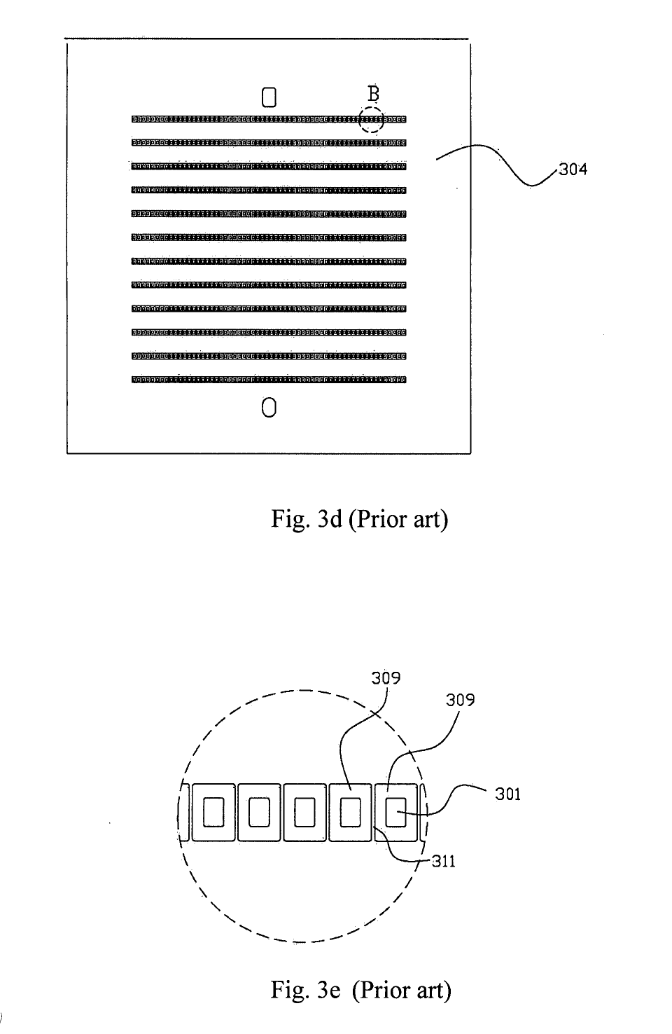

### DETAILED DESCRIPTION OF ILLUSTRATED EMBODIMENTS

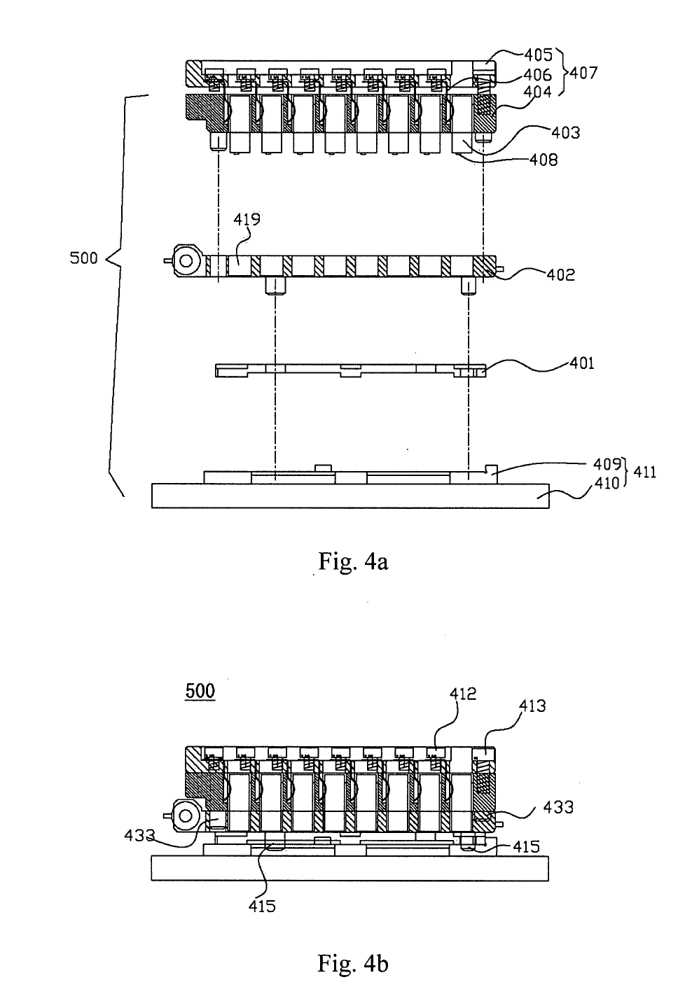

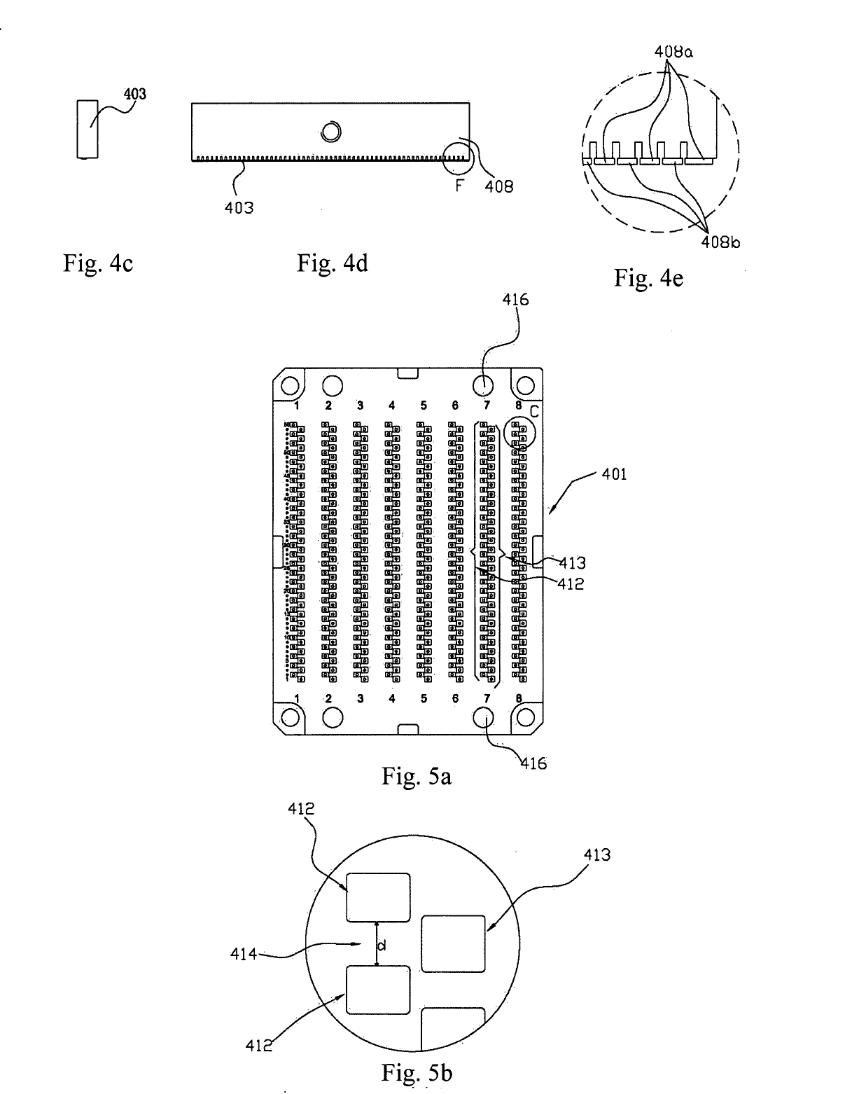

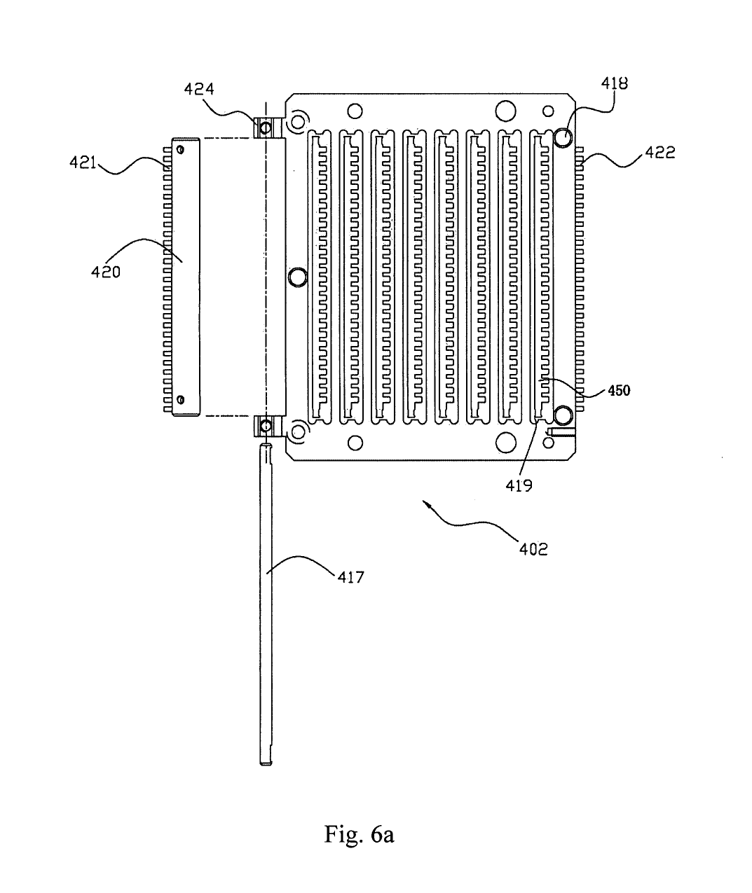

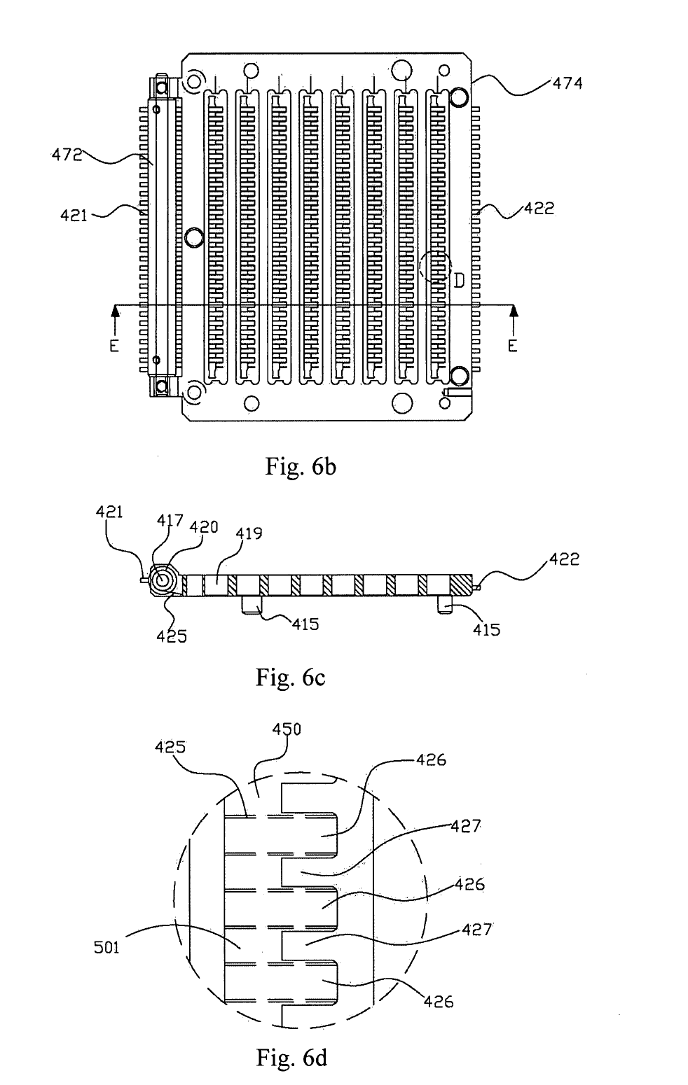

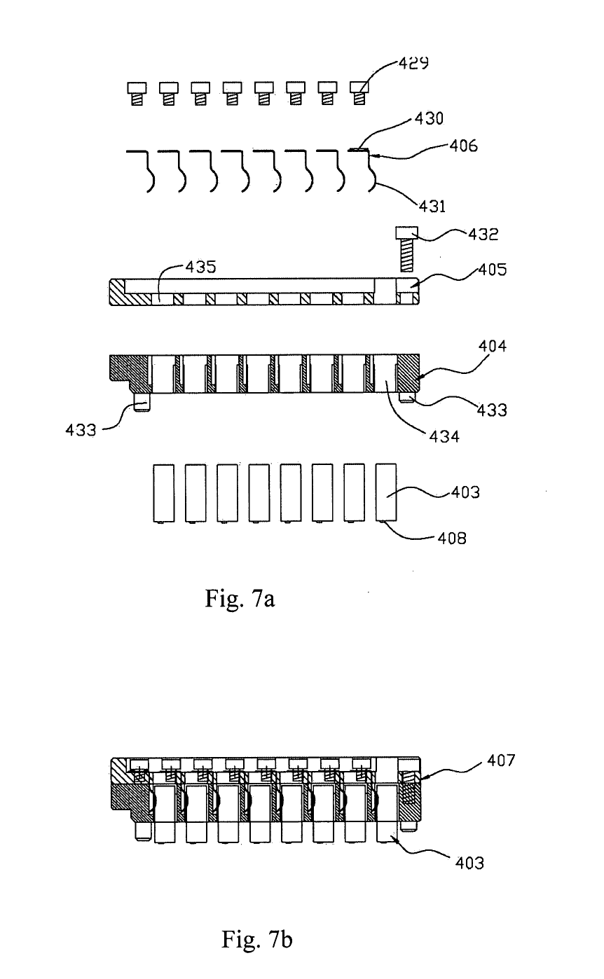

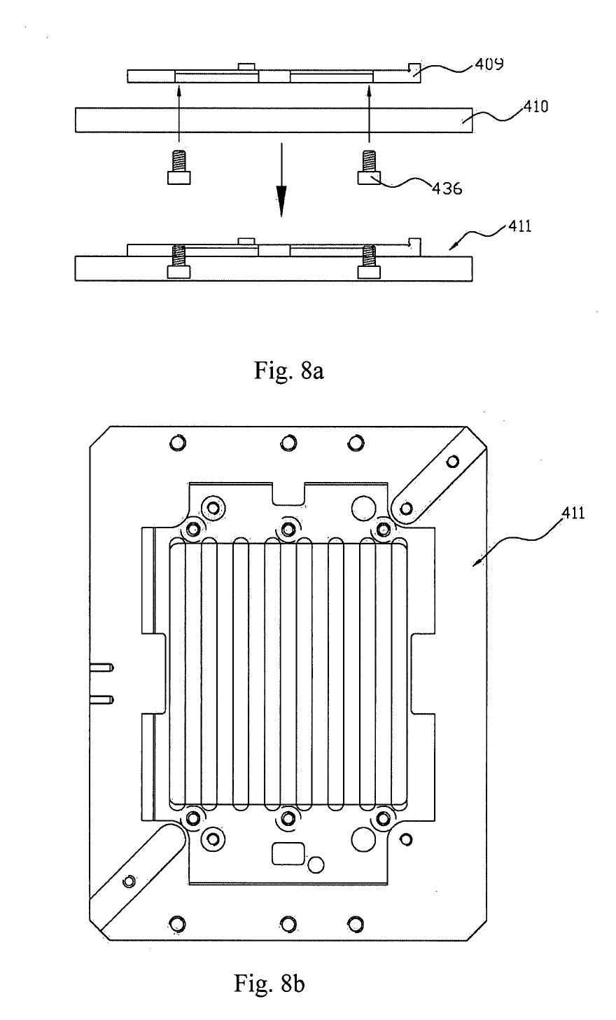

FIGS. 4a-5b and FIGS. 7a-7b illustrate an auxiliary slider-debonding device 500 for debonding a plurality of sliders from a transfer tool 403 according to an embodiment of the invention. As shown in FIGS. 4c-4d, the auxiliary slider-debonding device 500 of the invention is used to debond a plurality of sliders 408 from a surface of the transfer tool 403 and collect these separated sliders 408 together, thus facilitating subsequent slider selecting work. The plurality of sliders 408 commonly is attached to a surface of the transfer tool 403 via adhesive such as bonding glue or wax. Then, by immersing the transfer tool 403 into a suitable solution, the adhesive is dissolved such that the sliders 408 are separated from the transfer tool 403. As shown in FIGS. 4a-4b, the auxiliary slider-debonding device 500 comprises a locating device 407 to locate a plurality of transfer tools 403, a debonding tray 401 under the locating device 407 to receive the sliders 408, a guardrail plate 402 disposed between the locating device 407 and the debonding tray 401 and parallel to them, and a support plate 411 to support the locating device 407, the debonding tray 401 and the guardrail plate 402.

The locating device 407 comprises a locating plate 404 disposed over and parallel to the debonding tray 401; a spring-mounting plate 405, which is mounted on the locating plate 404 by suitable manner such as a plurality of screws 432 and which has a plurality of holes 435 formed therein; and a plurality of springs 406 engaged with both the locating plate 404 and the spring-mounting plate 405. The locating plate 404 has a plurality of mounting-slots 434 formed therein for accommodating the transfer tool 403. Each spring 406 comprises a horizontal portion 430 and a resilient contact portion 431 connected with the horizontal portion 430. The horizontal portion 430 of the spring 406 is secured on a top position of a respective hole 435 by suitable manner such as a screw 429. Since each mounting-slot 434 is aligned with a respective hole 435, the resilient contact portion 431 of the spring 406 passes through the hole 435 and is received in the mounting-slot 434. In addition, the resilient contact portion 431 resiliently touches an inner sidewall of the mounting-slot 434. The transfer tool 403 can be stably mounted in the mounting-slot 434 due to resilient contact between the resilient contact portion 431 and the mounting-slot 434.

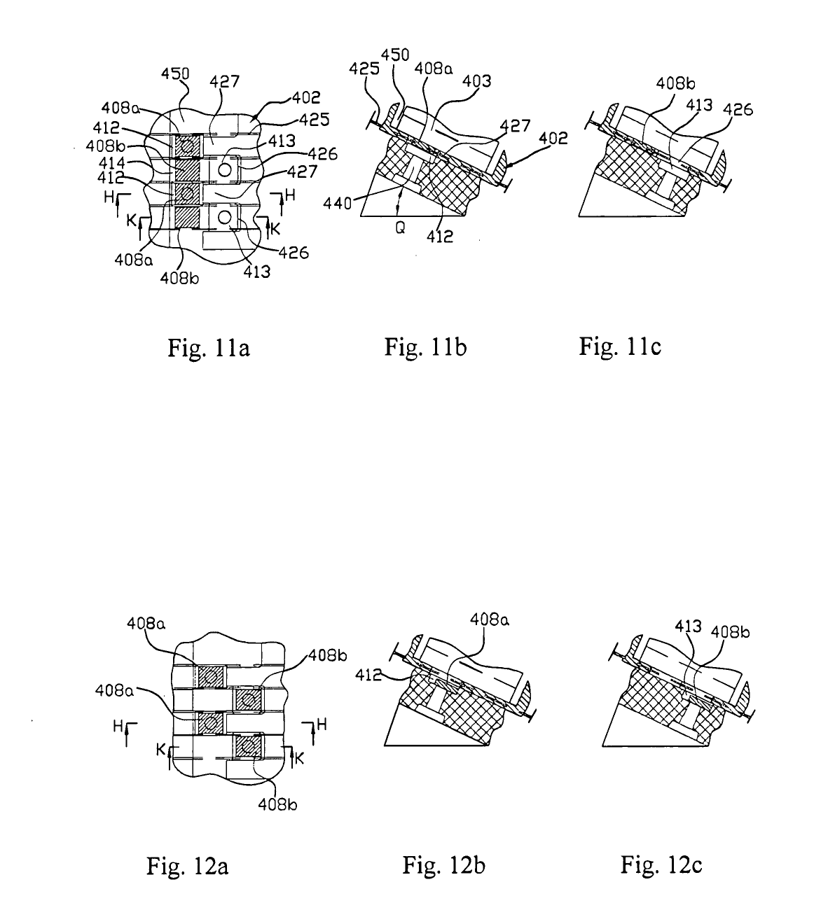

Referring to FIGS. 5a-5b, the debonding tray 401 comprises at least an array of first pockets 412 arranged in a direction consistent with the arranging direction of the sliders carried on the transfer tool 403, and an array of second pockets 413 arranged in a direction parallel to the array of first pockets 412. A stage 414 is defined between any two adjacent first pockets 412, and the length of the stage 414 along the arranging direction of the first pockets 412, i.e., the distance d between two adjacent first pockets 412, is larger than the length of a slider along the same direction. Along the arranging direction of the first pockets 412, each second pocket 413 has the same position as an adjacent stage 414. More specifically, the array of the first pockets 412 is parallel to and offsets from the array of the second pockets 413. Each stage 414 defined between two adjacent first pockets 412 is corresponding to respective second pocket 413, while each gap formed between two adjacent second pockets 413 is corresponding to respective first pocket 412. In addition, each first pocket 412 and second pocket 413 has a through hole 440 formed on the bottom thereof (refer to FIGS. 11a-11c). When the auxiliary slider-debonding device 500 is soaked in a solution so as to dissolve the adhesive, the solution can flow through the through holes 440 and come into the pockets such that the solution can touch the slider and the adhesive, both of which are positioned over the pocket, thus making the adhesive dissolved.

After the transfer tool 403 is assembled to the locating device 407, the plurality of the sliders 408 carried on the transfer tool 403 faces downwardly and is located over the first pockets 412 and the stages 414. Thus, the sliders 408 can directly fall into the first pockets 412 or drop on the stages 414 respectively after they are separated from the transfer tool 403.

There is a distance between each first pocket 412 and an adjacent second pocket 413 in a direction perpendicular to the arranging direction of the first pockets 412. Preferably, the distance is ⅔-¼ of the length of the first pocket 412 along the direction perpendicular to the arranging direction of the first pockets 412. It has been proved by experiment that if the distance falls into the above range, a big slope angle can be obtained for the auxiliary slider-debonding device when the device is immersed in the solution. Moreover, when the distance falls into the range, the sliders dropped on the stages can slip into respective second pockets more easily and quickly.

The guardrail plate 402 may assure that the sliders will drop in correct pockets more accurately. The guardrail plate 402 is disposed between the locating device 407 and the debonding tray 401, and parallel to them. The guardrail plate 402 is assembled to both of them. In another embodiment of the invention, the guardrail plate 402 may be separate away from the debonding tray 401 and the distance therebetween is smaller than the thickness of a slider (the distance between the guardrail plate 402 and the debonding tray 401 may be regarded as zero in case they are assembled together). Correspondingly, at least one receiving-slot 450, which extends along a direction consistent with the arranging direction of the array of first pockets 412, is formed on the bottom of the guardrail plate 402. A plurality of stoppers 427 is formed on one side of the receiving-slot 450 and these stoppers 427 extend toward an opposite side of the slot 450. A gap 501 is defined between each stopper 427 and the opposite side of the receiving-slot 450. Each gap 501 locates over the array of the first pockets 412. A notch 426 is defined between any two adjacent stoppers 427, and the notches 426 locate over the array of the second pockets 413. A plurality of locating slots 419, which communicate with respective receiving-slots 450 and which are used to secure the transfer tools 403, is defined on the top of the guardrail plate 402.

More specifically, one end portion of each transfer tool 403, on which the sliders 408 are attached, is partially received in respective locating slot 419 (as shown in FIG. 4b), while the sliders 408 are placed in the gaps 501 formed between the opposite side of the receiving-slot 450 and respective stoppers 427 (refer to FIG. 11a). After the sliders 408 are disengaged from the transfer tool 403 and approach the debonding tray 401, the sliders corresponding to the first pockets 412 are stopped by the stoppers 427 and therefore directly drop into the first pockets 412, while the sliders corresponding to the stages 414 directly slip away from the stages 414 and fall into the second pockets 413 due to restraint of the notches 426.

In addition, a guiding wire 425 is provided between each notch 426 and adjacent stopper 427 of the guardrail plate 402 for guiding movement of respective slider. The guiding wire 425 extends from one side of the receiving-slot 450, on which the notches 426 are formed, to the other side. In another embodiment of the invention, the guiding wire may be disposed only in respective gap 501. Specifically, the guiding wire may be disposed in the gap 501 and extend along two lateral sides of the notch. In addition, the guardrail plate 402 has two side portions 472, 474 parallel to the receiving-slot 450. A plurality of securing posts 422 is formed on the side portion 474. One end of each guiding wire 425 is tied on corresponding securing post 422 and the other end thereof is adjustably fixed on the other side portion 472. Two shaft carriers 424 each having a shaft-receiving hole defined therein (not labeled) are formed at two lateral sides of the side portion 472 of the guardrail plate 402. A wire-adjusting shaft 420 is pivotally mounted on both the two shaft carriers 424 by inserting a pin 417 through itself and through the shaft-receiving holes of the two shaft carriers 424. A plurality of tension-adjusting posts 421 corresponding to the securing posts 422 is provided on the wire-adjusting shaft 420 and the other end of the guiding wire 425 is fixed on respective tension-adjusting post 421. The tension force of the guiding wire 425 is adjusted by rotating the wire-adjusting shaft 425. A bigger tension may enhance guiding effect of the guiding wire 425 on movement of the slider.

After the sliders are debonded from the transfer tool and then dropped to the debonding tray, location confusion does not happen between adjacent sliders, since the sliders are isolated from each other by the guiding wires 425. In addition, each guiding wire 425 disposed at two sides of the slider prevents the slider from deviating its proper position. For example, it can be assured that each slider, which fell on respective stage, will correctly drop into respective second pocket corresponding to the stage and will not drop into other pocket, thus improving accuracy of the sliders being correctly received, reducing or avoiding confusion condition of the sliders. For example, the slider confusion rate of a conventional solvent debonding method is about 5%, while the method of the invention reduces it to 2%-0.8%, thus greatly facilitating slider selecting work in subsequent process.

Furthermore, a plurality of register posts 433 is provided on the locating plate 404 of the locating device 407, and correspondingly, a plurality of register holes 418 is provided on the guardrail plate 402. Each register post 433 is inserted into respective register hole 418. Similarly, the guardrail plate 402 provides a plurality of register posts 415 thereon, and correspondingly, the debonding tray 401 provides a plurality of register holes 416 thereon. Each register post 415 is inserted into respective register hole 416. The engagement of the register posts 415 with respective register holes 416 may assure precise alignment between the sliders carried on the transfer tool, the corresponding structure of the guardrail plate 402 (the gaps 501 formed between the stoppers 427 and the other side of the receiving-slot 450) and corresponding structure of the debonding tray 401 (the first pockets 412 and the stages 414), thus reducing or even avoiding slider confusion during a slider-receiving process.

The support plate 411 comprises a bottom plate 410 and an assembling plate 409 mounted on the bottom plate 410 by several screws 436. The support plate 411 steadily carries the locating device 407, the debonding tray 401 and the guardrail plate 402 thereon. When the auxiliary slider-debonding device 500 is obliquely put in a solution for dissolving the adhesive, the support plate 411 can enhance stiffness and stability of the auxiliary slider-debonding device 500.

According to a tilting slider debonding method of the invention (which will be described in greater detail later), the auxiliary slider-debonding device may be obliquely immersed in a tank containing suitable solution such that the location of the first pockets 412 are higher than that of the second pockets 413 of the debonding tray 401. Then the solution dissolves the adhesive attached on the transfer tool 403 such that the sliders 408 are debonded from the transfer tool 403 and directly drop into the first pockets 412 therebelow due to gravity, or drop to the stages 414 and then slip into the second pockets 413 due to gravity, thus realizing debonding and receiving of the sliders. During sliders dropping process, the distance between two adjacent first pockets is so large (at least not less than the width of the slider) that slider location confusion will less probably occur among the sliders which fell directly in the first pockets. As both the distance between two adjacent stages (namely, the length of the first pocket in the arranging direction of the array of the first pockets) and the distance between two adjacent second pockets (namely the distance d between two adjacent first pockets) are large enough, the sliders fell on the stages will not easily confuse with each other. Furthermore, the sliders will not confuse with each other during process of slipping into the second pockets, hence assuring that the sliders slipped into the second pockets will have correct position.

Though in the above embodiments of the invention, the auxiliary slider-debonding device 500 comprises the locating device 407, the debonding tray 401, the guardrail plate 402 and the support plate 411; however, in other embodiments of the invention, the auxiliary slider-debonding device may not contain the guardrail plate or the support plate, but good slider-debonding effect may still be obtained.

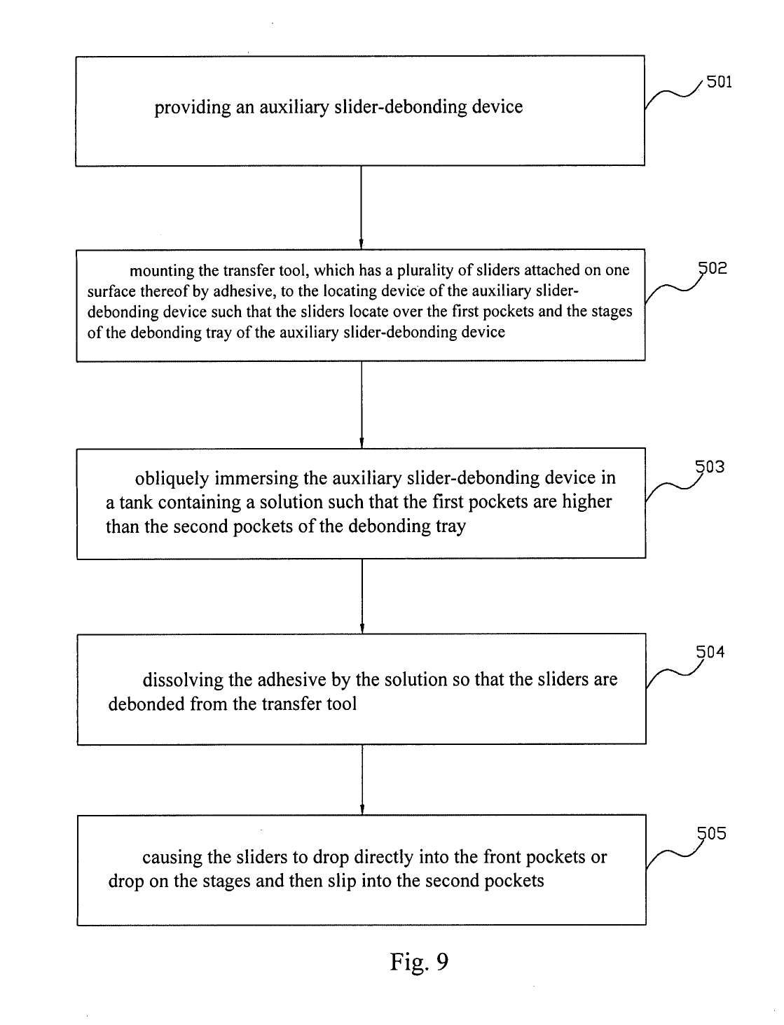

FIG. 9 illustrates a flowchart of a slider debonding method using the auxiliary slider-debonding device described above according to an embodiment of the invention. As illustrated, the method comprises the steps: at first, providing the aforementioned auxiliary slider-debonding device 500 (step 501); then, mounting the transfer tool, which has a plurality of sliders attached on its one surface by adhesive, to the locating device of the auxiliary slider-debonding device such that the sliders locate over the first pockets and the stages of the debonding tray of the auxiliary slider-debonding device (step 502); next, obliquely immersing the auxiliary slider-debonding device in a tank containing a solution such that the first pockets are higher than the second pockets of the debonding tray (step 503); next, dissolving the adhesive by the solution so that the sliders are debonded from the transfer tool (step 504); and finally, causing the sliders to drop into the first pockets or drop on the stages and then slip into the second pockets (step 505).

The solution used to dissolve the adhesive may contain NMP (N-Methyl-2-Pyrrolidone) or IPA (isopropyl alcohol) solvent or other chemical compound. The incline angle (represented by numeral Q in FIG. 11b) of the auxiliary slider-debonding device relative to the horizontal plane is about 10-75 degree, and preferably the incline angle is 45 degree.

In an embodiment of the invention, the step 501 further comprises a step of providing a guardrail plate. The guardrail plate is disposed between the locating device and the debonding tray. The guardrail plate is parallel to the locating device and the debonding tray. The distance between the guardrail plate and the debonding tray is smaller than the thickness of the sliders. At least one receiving-slot, which extends along a direction consistent with the arranging direction of the array of first pockets, is formed on the guardrail plate. A plurality of stoppers is formed on one side of the receiving-slot and the stoppers extend toward an opposite side of the slot. A gap is defined between each stopper and the opposite side of the receiving-slot, and each gap locates over the array of the first pockets. A notch is formed between any two adjacent stoppers, and the notch locates over the array of the second pockets. In the step 504, the sliders corresponding to the first pockets are stopped by the stoppers and directly drop in the first pockets. The sliders corresponding to the stages are stopped by the notches and drop in the second pockets, thus assuring that the sliders can drop in correct pockets.

In addition, the step of providing the guardrail plate may further comprise a step of forming a plurality of guiding wires between the notches and the adjacent stoppers. Each guiding wire extends from one side of the receiving-slot, on which the notches are formed, toward the other side thereof. In the step 504, adjacent sliders are separated from each other and restrained by the guiding wires such that the sliders drop in the first pockets correctly or slip from the stages to the second pockets, thus improving accuracy of the sliders falling into the pockets, avoiding or reducing confusion between the sliders.

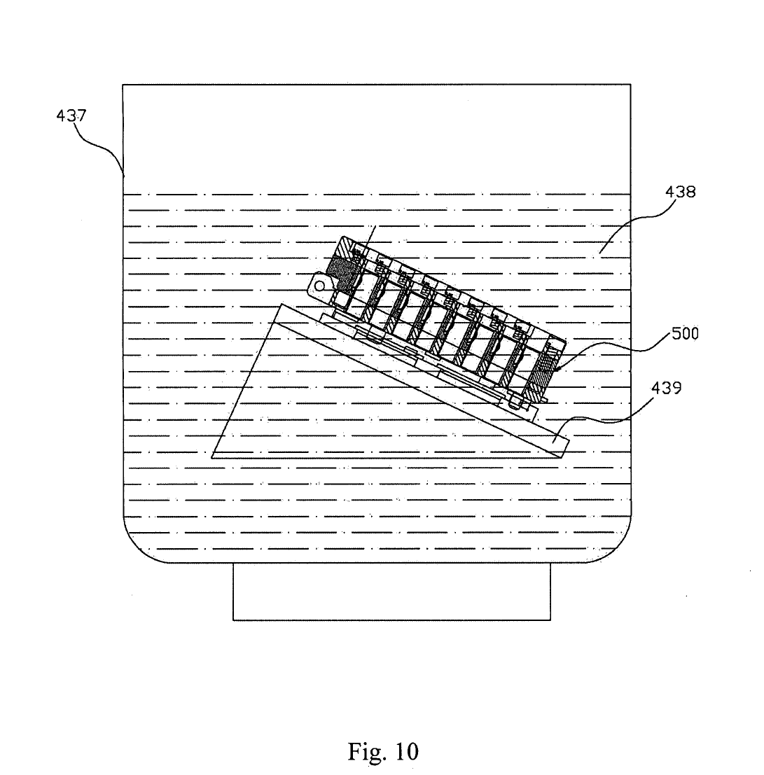

FIG. 10 illustrates a status of obliquely placing the auxiliary slider-debonding device 500 in a tank 437 containing suitable solution 438. It is noted that when putting the auxiliary slider-debonding device in the solution, the position of the first pockets must be higher than that of the second pockets. Thus, the sliders fell on the stages can slip into the second pockets. Here, a tilting holder 439 is used to realize oblique placement of the auxiliary slider-debonding device.

FIGS. 11a-11c show a status after a plurality of sliders is separated from the transfer tool but before they are dropped into respective pockets. As illustrated, the sliders 408a are restrained to locate over the first pockets 412 and the sliders 408b are restrained on the stages 414 respectively, because they are restrained and guided by the stoppers 427 of the guardrail plate 402 and the guiding wires 425. Thus the sliders 408b can only slip in the second pockets 413 adjacent the stages 414, hence avoiding confusion among the sliders. FIGS. 12a-12c illustrate a status of the sliders dropped in the corresponding pockets after they are separated from the transfer tool. As illustrated, the sliders 408a dropped in the first pockets 412 while the sliders 408b dropped in the second pockets 413.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An auxiliary slider-debonding device for debonding a plurality of sliders from a transfer tool and receiving them therein, comprising:
a locating device to locate the transfer tool; and
a debonding tray to receive the sliders, wherein
the debonding tray comprises at least an array of first pockets arranged in a direction consistent with an arranging direction of the sliders on the transfer tool, and an array of second pockets arranged in a direction parallel to the array of first pockets; wherein a stage is defined between any two adjacent first pockets, and the length of each stage along the arranging direction of the array of first pockets is larger than the length of a slider along the same direction; wherein each second pocket has a same position as that of a closest stage along the arranging direction of the first pockets.

2. The device according to claim 1, wherein further comprising a guardrail plate disposed between the locating device and the debonding tray and parallel to them, and the distance between the guardrail plate and the debonding tray is smaller than the thickness of a slider; wherein at least a receiving-slot parallel to the arranging direction of the array of first pockets or second pockets is defined on the guardrail plate, and the receiving-slot comprises a gap corresponding to the array of first pockets, and a plurality of notches that are formed at one side of the gap and corresponding to the array of second pockets; wherein a stopper is defined between any two adjacent notches for restraining position of the sliders.

3. The device according to claim 2, wherein the guardrail plate further has a locating slot defined therein which communicates the receiving-slot and which is used to locate the transfer tool.

4. The device according to claim 2, wherein a guiding wire is provided in the gap and extended along two lateral sides of each notch to guide movement of each slider.

5. The device according to claim 2, wherein the guardrail plate has two side portions parallel to the receiving-slot; a plurality of securing posts is formed on one of the side portions, one end of each guiding wire is tied on respective securing post and the other end thereof is adjustably tied on the other side portion of the guardrail plate.

6. The device according to claim 5, wherein a wire-adjusting shaft is mounted on the other side portion of the guardrail plate; a plurality of tension-adjusting posts corresponding to the securing posts is formed on the wire-adjusting shaft; the other end of each guiding wire is tied on respective tension-adjusting post, and the tension of the guiding wires is adjusted by rotating the wire-adjusting shaft.

7. The device according to claim 2, wherein the guardrail plate has a plurality of register posts formed thereon, the debonding tray has a plurality of register holes formed thereon corresponding to the register posts, and the register posts are inserted into the register holes respectively.

8. The device according to claim 1, wherein the locating device comprises a locating plate positioned over and parallel to the debonding tray, and the locating plate has a mounting-slot for mounting the transfer tool therein.

9. The device according to claim 8, wherein the locating device further comprises a spring constructed by a horizontal portion and a resilient contact portion connected to the horizontal portion; and the resilient contact portion passes through the mounting-slot and resiliently touches an inner sidewall of the mounting-slot.

10. The device according to claim 9, wherein the locating device further comprises a spring-mounting plate which is assembled on the locating plate and which has a hole defined therein; the hole is aligned with the mounting-slot; and the horizontal portion of the spring is secured on a top position of the hole.

11. The device according to claim 1, wherein further comprising a support plate for supporting the locating device and the debonding tray; and the support plate is constructed by a bottom plate and an assembling plate assembled on the bottom plate.

12. A method for debonding a plurality of sliders from a transfer tool and receiving them together, comprising the steps of:
(1) providing an auxiliary slider-debonding device as recited in claim 1;
(2) mounting the transfer tool, which has a plurality of sliders attached on one surface thereof by adhesive, to the locating device of the auxiliary slider-debonding device such that the sliders locate over the first pockets and the stages of the debonding tray of the auxiliary slider-debonding device;
(3) obliquely immersing the auxiliary slider-debonding device in a tank containing a solution such that the location of the first pockets are higher than that of the second pockets of the debonding tray;
(4) dissolving the adhesive by the solution so that the sliders are debonded from the transfer tool;
(5) cuasing the sliders to drop into the front pockets or drop on the stages and then slip into the second pockets.

13. The method according to claim 12, wherein the solution contains IPA or NMP or other chemical compound.

14. The method according to claim 12, wherein in the step (2), the slope angle of the auxiliary slider-debonding device respect to the horizontal plane is 10-75 degrees.

15. The method according to claim 12, wherein the step (1) further comprise a step of providing a guardrail plate which is disposed between the locating device and the debonding tray and parallel to them; the distance between the guardrail plate and the debonding tray is smaller than the thickness of the slider; the guardrail plate has at least a receiving-slot formed therein which extend along a direction consistent to the arranging direction of the array of first pockets; a plurality of stoppers is formed at one side of the receiving-slot and a gap is defined between each stopper and the other side of the receiving-slot, and the gap locates over respective first pocket; a notch is defined between any two adjacent stoppers, and each notch locates over respective second pocket.

16. The method according to claim 15, wherein the step of providing the guardrail plate further comprises a step of forming a guiding wire between each notch and adjacent stopper, and the guiding wire extends from one side, on which the guiding wire is formed, to the other side.
